(19) United States
(12) Patent Application Publication
(10) Pub. No.: US 2006/0140288 A1
(43) Pub. Date: Jun. 29, 2006

(54) System and method for transmission and reception of multicarrier data signals

(75) Inventor: Roger Holden, Lawrence, KS (US)

Correspondence Address: Stephen R. Robinson, 1121 Pennsylvania, Lawrence, KS, 66044, US

(73) Assignee: 21st Century Sound and Vision, Inc.

(21) Appl. No.: 11/022,970

(22) Filed: Dec. 27, 2004

(51) Int. Cl. H04K 1/10

(52) U.S. Cl. 375/260

(57) ABSTRACT

Apparatus and method for transmitting information, utilizing a multicarrier waveform containing the information. The waveform presents symmetrically-shaped first and second sequential portions which are substantially equal in length. All subcarriers are restricted in phase values to 0 and π, or alternatively, π/2 and 3π/2. One, but not both, of the portions is transmitted to a receiver. The transmitted portion is duplicated and the duplicated portion is than reversed. The duplicated portion is also inverted in the case where the phase values are restricted to 0 and π. The duplicated, processed portion is then sequentially combined with the originally transmitted portion to reform substantially the original waveform. Thus the invention dramatically reduces the length of the waveform to be transmitted, thereby increasing transmission and reception rates while minimizing the number of calculations required.

### BACKGROUND OF THE INVENTION

1. Field of the Invention

The present invention pertains to systems for the transmission and reception of multicarrier data signals. More particularly, the invention is an improved method of multicarrier modulation and demodulation for faster transmission.

2. Description of Related Art

Software algorithms and hardware for the implementation of multicarrier systems in transceivers are well known by those versed in the art. Some of the many algorithms include FFT/IFFT routines, equalization methods, parallel to serial conversion, error correction coding, subcarrier adaptive bit rates, echo cancellation, Doppler compensation and channel impulse response shortening. Hardware components include DSPs, DACs, ASICs and ADCs among others. These hardware and software components for multicarrier systems are not limited to the aforementioned but are for illustrative purposes only.

Many contemporary multicarrier communications systems generate and transmit data-encoded, summed, orthogonal subcarriers at the transmitter then analyze their spectrum at the receiver for recovery of as much transmitted data as possible. In practice the IFFT and FFT (inverse fast Fourier transform and fast Fourier transform respectively) are most commonly used to create and analyze these waveforms. The process is commonly referred to as OFDM or Orthogonal Frequency Division Multiplexing or when OFDM is used in conjunction with coding techniques, it may be referred to as coded orthogonal frequency division multiplexing (COFDM). When an IFFT/FFT multicarrier modulation/demodulation system is combined with polyphase filterbank modulation it is called Filtered Multitone Modulation.

The use of the Fourier transform to generate multicarrier waveforms for data communications has been known in the prior art for over 30 years. For example such a system was presented in great detail in “Data Transmission by Frequency Division Multiplexing Using the Discrete Fourier Transform,” S. B. Weinstein and P. M. Ebert, IEEE Trans. Commun. Tech., vol. COM-19, pp. 628-634, October 1971, which is hereby incorporated by reference. U.S. Pat. No. 4,833,706 Hughes-Hartog, Ensemble Modem Structure for Imperfect Transmission Media, describes a digital modem design which uses Fourier/Inverse Fourier OFDM multicarrier techniques.

A detailed discussion of the principles of OFDM multicarrier transmission and reception is given in J. A. C. Bingham, “Multicarrier Modulation For Data Transmission: An Idea Whose Time has Come,” EEE Commun. Mag., pp 5-14, May, 1990, which is hereby incorporated by reference.

OFDM is the modulation method used in the IEEE 802.11a/g WLAN standard. It is also frequently used in xDSL applications such as ADSL and VDSL in which existing copper wires are used to achieve high-speed data connections. COFDM is also now widely used in Europe and elsewhere where the Eureka 147 Digital Audio Broadcast standard has been adopted for digital radio broadcasting, and also for digital TV in the DVB digital TV standard.

The conventional OFDM communication apparatus should be optimized in terms of both transmission/reception rates and flexibility of functions, as discussed by Matsumoto in U.S. Pat. No. 6,731,595, at col. 2, ll. 20-24. To address this Matsumoto discloses a multicarrier modulation and demodulation system using “a half-symbolized symbol.” This technique utilizes a transmission unit which generates a half-symbol by carrying out an inverse Fourier transform to a signal after BPSK modulation and transmits the half-symbol, and then a reception unit carries out a predetermined Fourier transform to the received half-symbol in order to extract even subcarriers and demodulate the data allocated to the even subcarriers. The system then carries out an inverse Fourier transform to the data allocated to the even subcarriers to generate a first symbol that is structured with a time waveform of even subcarriers. Matsumoto then removes the first symbol component from the received symbol to generate a second symbol that is structured with a time waveform of odd subcarriers, adds a symbol obtained by copying and inverting the symbol to the back of the second symbol to generate a third symbol, and then carries out a predetermined Fourier transform to the third symbol in order to extract odd subcarriers and demodulate the data allocated to the subcarriers.

While this extraction process could lead to an increase in the data transmission rate in a multicarrier system, its implementation requires a tremendous amount of computations not required by the present invention. For example, for a 128 sample half-symbol transmitted to a receiver, Matsumoto, at a minimum, requires at the receiver a 128 length FFT process to extract 64 even numbered subcarriers, col. 12, ll. 4-6, followed by a 128 length IFFT process, col. 12, ll. 20-24 plus a 256 length FFT process to extract the remaining 64 odd numbered subcarriers, col. 12, ll. 37-40.

What is needed is a communication apparatus, and a method which robustly increases transmission and reception rate with minimized, efficient computation requirements.

### SUMMARY OF THE INVENTION

The present invention constitutes a process of creating data-encoded multicarrier waveforms which can be split into two substantially symmetrical halves (each a half-symbol) and transmitting only one of those halves across a communications channel to a receiver. In descriptive terms, the two halves are reversed (and in some cases also inverted) copies of each other. Only one half need be computed and sent over a channel to a receiver, as opposed to conventional multicarrier modulation techniques, which would require transmission of both halves, that is to say, the full symbol generated by a conventional transmitter.

The receiver takes the received half-symbol, duplicates it, reverses (and sometimes inverts) this duplication. The modified duplicated waveform is appropriately attached to the previously received half-symbol, thereby creating a synthetic version of the original full multicarrier symbol. The synthetic full-symbol version is then analyzed for data recovery.

Therefore, it is an object of the present invention to provide a communication apparatus and a communication method which improves transmission and reception rates while minimizing calculations. For example, in contradistinction to the extraction process in the receiver as cited above in Matsumoto, the present invention at the receiver would instead only require one 256 length FFT process to obtain the total 128 subcarriers, thus greatly reducing the computational steps.

Advantageously, the present invention provides a method of transmitting information, utilizing a waveform containing the information. The waveform presents symmetrically-shaped first and second sequential portions which are substantially equal in length. One, but not both, of the portions is transmitted to a receiver. The transmitted portion is duplicated and the duplicated portion is than reversed and, if appropriate, inverted. The duplicated, processed portion is then sequentially combined with the originally transmitted portion to reform substantially the original waveform. Thus the invention dramatically reduces the length of the waveform to be transmitted, thereby increasing transmission and reception rates while minimizing the number of calculations required.

### BRIEF DESCRIPTION OF THE DRAWINGS FIG. 1 shows a block diagram of a generic multicarrier transceiver system which incorporates the present invention;

FIG. 2 shows a typical multicarrier waveform in the time domain where the phase values of the subcarriers are restricted to 0 and π, in accordance with the present invention;

FIG. 3 shows a typical multicarrier waveform in the time domain where the phase values of the subcarriers are restricted to π/2 and 3π/2, in accordance with the present invention;

FIG. 4 illustrates a half-symbol with all subcarrier phase values restricted to 0 and π in accordance with the present invention;

FIG. 5 illustrates a synthetic full symbol with subcarrier phase values of 0 and π in accordance with the present invention;

FIG. 6 illustrates a half-symbol with subcarrier phase values of π/2 and 3π/2 in accordance with the present invention; and

FIG. 7 illustrates a synthetic full symbol with subcarrier phase values of π/2 and 3π/2 in accordance with the present invention.

### DETAILED DESCRIPTION

Those skilled in the art may discern from the following inventive embodiments the requirements of incorporating the present invention into any multicarrier transmitter and receiver system. For example, it is possible to apply the present invention to all communication apparatus that carry out wire communications and wireless communications based on a multicarrier modulation/demodulation system.

FIG. 1 shows a block diagram of a generic multicarrier transceiver system which incorporates the present invention. The purpose of this diagram and embodiment is to illustrate the great diversity of options that the present invention may implement in a multicarrier transceiver environment.

The present invention may be incorporated into a great variety of multicarrier technologies including without limitation xDSL, CATV, OFDM-CDMA, hybrids, OFDMA, Filtered Multitone Modulation, fiber optics, wireless, satellite and powerline communications.

Although 128 subcarriers are assumed for illustrative purposes, the number of subcarriers is not limited to this number in implementing the present invention. When the number of subcarriers is other than 128, the associated lengths of the 256 FFT and the 256 IFFT also change corresponding to the number of the subcarriers.

Now referring to the drawings in general and FIG. 1 in particular, a system 10 embodying the present invention is depicted in block diagram form. System 10 includes a signal line 12, a transmitter 14, a communication channel 15, a receiver 16 and an output signal line 18. Although system 10 is illustrated as a channel communication platform, it will be readily appreciated by those skilled in the art that the platform could in fact utilize wireless or other modalities, or hybrids thereof, for transmission. Examples include copper lines, fiber optics, powerline networks, etc.

Signal line 12 is an input line for transmitter 14. Signal line 12 carries a bit stream which may be encoded in a variety of ways as is typical in multicarrier systems as a way of protecting against distortions to be encountered on the channel. The bit stream may also represent a multiplex situation where a bit or particular group or groups of bits in the stream are to be allocated ultimately to differing users such as in OFDM-CDMA and OFDMA.

Transmitter 14 includes a serial-to-parallel line-conversion element 19, a half-symbol processor 20, a connecting line 22, a cyclic prefix processor 24, a connecting line 26, an additional processor 28, a connecting line 30, a DAC processor 32 and an output line 33.

Line-conversion element 19 is suitable for accepting a serial bit stream and inputting the stream as parallel bit sets into half-symbol processor 20. Half-symbol processor 20 includes computational and other circuitry for accepting the parallel bit sets and outputting a half-symbol in accordance with the present invention as discussed below in the context of operation. Cyclic prefix processor 24, additional processor 28 and DAC processor 32 are elements well known in the art and will be further discussed in the context of operation.

Receiver 16 includes an input line 34, an ADC processor 36, a connecting line 38, a special process element 40, a connecting line 42, a cyclic prefix process element 44, a connecting line 46, a synthetic full symbol processer 48, a connecting line 50, a demodulation element 52 and an output line 54.

ADC element 36, special process element 40, cyclic prefix process element 44 and demodulation element 52 are elements well known in the art and will be further discussed in the context of operation.

Synthetic full symbol processor 48 includes computational and other circuitry for accepting and processing a digitized half-symbol to yield a synthetic full symbol in accordance with the present invention, as discussed below in the context of operation.

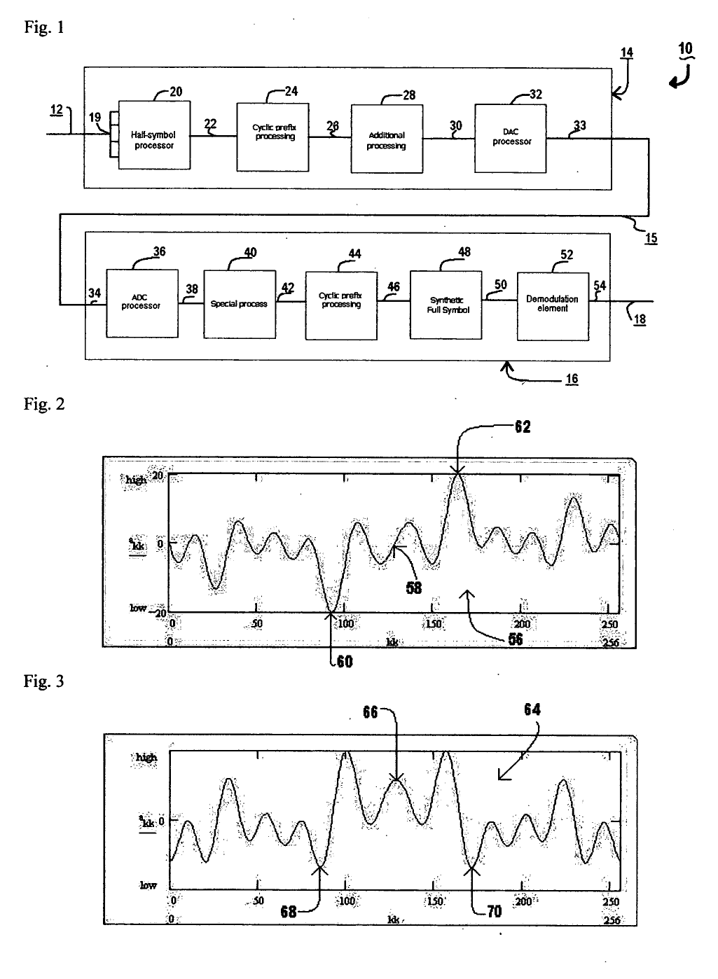

FIGS. 2 through 7 will be discussed in the description of operation. However, certain aspects of those figures will now be noted.

Referring to FIG. 2, an illustrative multicarrier waveform 56 is illustrated in the time domain. The horizontal axis is time and the vertical axis is amplitude. Waveform 56 embodies 256 samples with twelve subcarriers. Twelve subcarriers are used merely for ease of illustration in FIGS. 2 through 7. The midpoint of the waveform 56 is a point denoted at reference numeral 58. The phase of all subcarriers of waveform 56 is restricted to two values, namely 0 and π. When the phase of all subcarriers is so restricted, each sample and amplitude to the left of point 58 has a reversed and inverted counterpart on the right side of point 58, e.g. points 60 and 62. That is to say, reversed in the sense that points 60 and 62 are symmetrically disposed about midpoint 58 on the time axis and inverted in the sense that the magnitude of the respective amplitudes is equal in absolute value, but opposite in sign along the amplitude axis. In other words, the second half of waveform 56 is a reversed and inverted copy of the first half of waveform 56 as a consequence of the particular phase restrictions.

Referring to FIG. 3, another illustrative multicarrier waveform 64 in the time domain is illustrated. The horizontal axis is time and the vertical axis is amplitude. Waveform 64 embodies 256 samples with twelve subcarriers as in FIG. 2. The midpoint of waveform 64 is denoted as a point at reference numeral 66. The phase of all subcarriers of waveform 64 is restricted to two values, namely π/2 and 3π/2. Note that each sample and amplitude to the left of point 66 has a reversed counterpart on the right side of point 66, e.g. points 68 and 70. In other words, the second half of waveform 64 is a reversed copy (i.e. mirror image) of the first half of waveform 64.

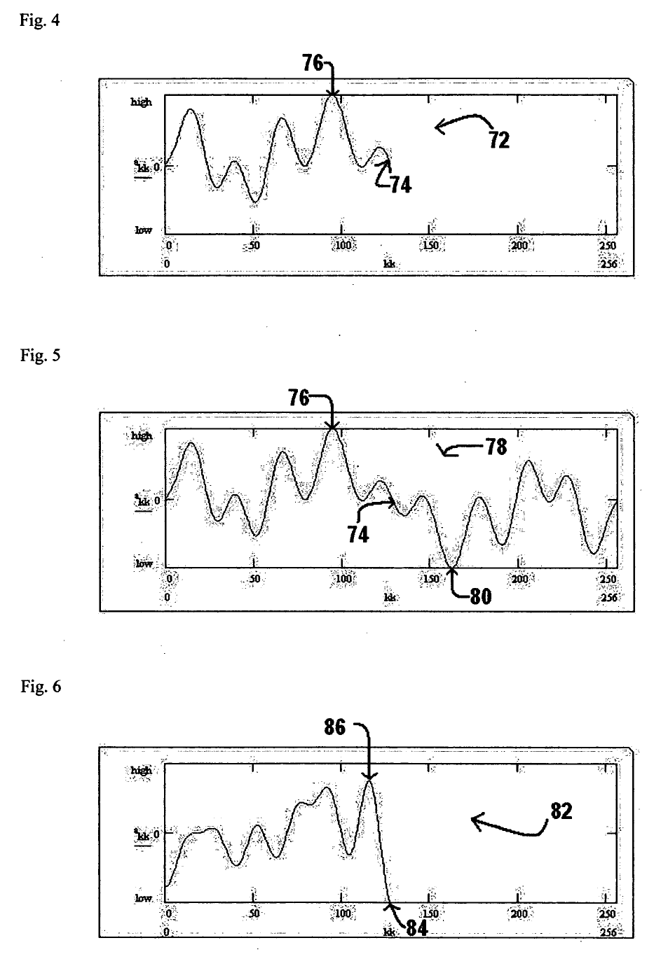

Referring to FIG. 4, a half-symbol 72 in the time domain is depicted. Half-symbol 72 presents an endpoint 74 and a peakpoint 76. The horizontal axis is time and the vertical axis is amplitude. Half-symbol 72. embodies 128 samples. The phase of all subcarriers of waveform 72 is restricted to two values, namely 0 and π.

Referring to FIG. 5, a synthetic full symbol 78 in the time domain is depicted. The horizontal axis is time and the vertical axis is amplitude. Synthetic full symbol 78 embodies 256 samples. The phase of all subcarriers of synthetic full symbol 78 is restricted to two values, namely 0 and π. Note that each sample and amplitude to the left of point 74 has a reversed and inverted counterpart on the right side of point 74, e.g. point 76 and a corresponding reversed and inverted point 80. In other words, the second half of synthetic full symbol 78 is a reversed and inverted copy of the first half of synthetic full symbol 78.

Referring to FIG. 6, a half-symbol 82 in the time domain is depicted. Half-symbol 82 presents an endpoint 84 and a peakpoint 86. The horizontal axis is time and the vertical axis is amplitude. Half-symbol 82 embodies 128 samples with twelve subcarriers. The phase of all subcarriers of half-symbol 82 is restricted to two values, namely π/2 and 3π/2.

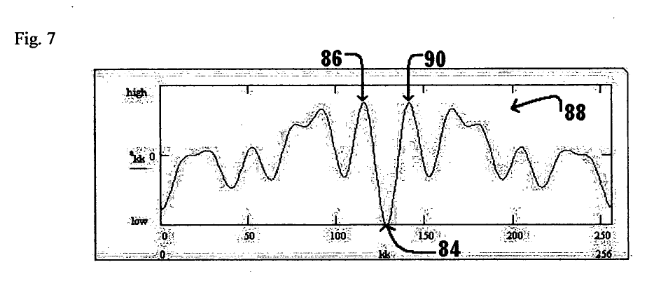

Referring to FIG. 7, a synthetic full symbol 88 in the time domain is depicted. The horizontal axis is time and the vertical axis is amplitude. Synthetic full symbol 88 embodies 256 samples with twelve subcarriers. The phase of all subcarriers of synthetic full symbol 88 is restricted to two values, namely π/2 and 3π/2. Note that each sample and amplitude to the left of point 84 has a reversed counterpart on the right side of point 84, e.g. points 86 and a corresponding reversed point 90. In other words, the second half of synthetic full symbol 88 is a reversed copy of the first half of synthetic full symbol 88.

Referring to FIG. 1, the operation of system 10 will now be discussed. In operation, a serial stream of bits flows on line 12 and is received by transmitter 14 at element 19. A consecutive group of the bits to be modulated onto the 128 carriers are arranged in a parallel fashion at element 19 into parallel bit sets and are input into half-symbol processor 20 which outputs a half-symbol, analogous to the half-symbol 72 (see FIG. 4). The processing which occurs at half-symbol processor 20 will be discussed in more detail after discussing the other processing occurring at transmitter 14 and receiver 16.

After processing by half-symbol processor 20 is completed, if required, a cyclic prefix (or suffix) is now attached to the computed half-symbol at element 24 to mitigate distortions created by the impulse response of communications channel 15 and for its other appropriate uses. The resultant time domain samples may be further processed by special digital filters, equalizers and digital processes at additional processor 28 to facilitate the efficient transmission of the half-symbol across channel 15. The computed time domain samples are then sent to DAC processor 32. The resultant analog half-symbol (plus attached cyclic prefix or suffix, if used) is then transmitted over channel 15.

The analog half-symbol (plus attached cyclic prefix or suffix, if used) is received at input line 34 and is then digitized by ADC element 36. The samples output by ADC element 36 may be further processed by special digital filters, equalizers and digital processes at special process element 40 to facilitate robust samples. As is well known in the art, if present, the cyclic prefix or suffix attached to the received half-symbol is processed, used and removed at element 44. Next the consecutive group of samples constituting the half-symbol are input into synthetic full symbol processor 48 in order to output a synthetic full symbol in accordance with the invention, as discussed below in more detail.

The synthetic full symbol is subjected to a demodulation process at element 52. This process includes a length 256 fast Fourier transform. The FFT reveals the 128 orthogonal related subcarriers of the synthetic full symbol. The Fourier coefficients of these subcarriers are subsequently used to demodulate the synthetic full symbol to recover the original data received at transmitter 14.

The processing occurring within half-symbol processor 20 in accordance with the invention will now be discussed in detail. In the prior art, a conventional full multicarrier symbol is generated at the transmitter. In the present invention a half-symbol (analogous to half-symbol 72 of FIG. 4 or half-symbol 82 of FIG. 6), substantially half the length of a conventional prior art symbol, is generated at processor 20.

This advantageous halving of the symbol length to be transmitted is possible because the present invention restricts phase values of the subcarriers to two values, namely 0 and π, (or alternatively π/2 and 3π/2) to exploit the symmetry illustrated in FIG. 2 (or alternatively FIG. 3 in the case of π/2 and 3π/2). Based on these phase restrictions, it becomes possible to compress the multicarrier symbol on the time axis, and expand the transmission capacity to about two times the normal capacity.

One way to compute the half-symbol is to first generate a conventional full symbol by using an IFFT (provided that phase values are restricted as discussed above). The parallel bit groups inputted to half-symbol processor 20 by element 19 are first appropriately converted to coefficients for subsequent input to the IFFT. The IFFT processes the coefficients and then outputs a conventional full symbol which is then substantially truncated in half to obtain the half-symbol which is eventually outputted from processor 20.

In implementation, a system designer must choose one pair of phase state options, i.e. either 0 and π or π/2 and 3π/2 with the same choice at both transmitter 14 and receiver 16. Pre-equalization may be introduced at this IFFT stage to pre-compensate for amplitude and phase distortions subsequently introduced by channel 15.

Each of the subcarrier's options for amplitude states, on the other hand, are freely variable and limited only for two possible reasons, not directly related to the inventive technique. One reason being that the protocol of the subcarrier modulation process demands the amplitude state limitation, such as in BPSK wherein the amplitude state remains constant. The other reason being that because of the particular physical constraints of communication channel 15, the set of states of amplitudes used for a particular subcarrier may vary so as to allow for an optimal bit rate on the subcarrier.

Depending on the constellations chosen (i.e. design choices for amplitude and phase states) for a particular implementation of the present invention, it may be necessary to consistently transmit n+1 samples as opposed to n samples, wherein n is the number of half of the samples comprising a conventional full multicarrier symbol. An implementation for transmitting n+1 samples would be required where, because of the set of constellations used, the IFFT might output a value for sample n+1 that cannot be anticipated at the receiver from just the transmitted first half samples or is not practically a known constant such as zero. In the case of n+1, the half-symbol to be output at processor 20 will be composed of 129 samples. In the case of n, the half-symbol to be output will be composed of 128 samples.

The processing occurring within synthetic full symbol processor 48 in accordance with the invention will now be discussed in detail. Processing at this stage may include equalization of the half-symbol to correct amplitude and phase distortions introduced by channel 15. Next element 48 takes the set of samples constituting the half-symbol and makes a modified copy of the set. If 129 (i.e. n+1) samples were transmitted then sample 129 (i.e. sample n+1) is not modified and is simply used as sample 129 (i.e. n+1) of the synthetic full symbol.

In the case of the phases for the particular implementation of the present invention being 0 and π, the modified copy is created by reversing the sample order of the received samples and multiplying each sample by a [−1] to invert. In the case of the phases for the particular implementation of the present invention being π/2 and 3π/2, the modified copy is created by just reversing the sample order of the received samples.

Regardless of the phase states chosen, the modified copy is then attached appropriately to the end of the set of processed received samples to form what will be referred to as the synthetic full symbol. This is a 256 sample full symbol resembling the original full waveform on the transmitter side. This synthetic full symbol is analogous to the synthetic full symbol 78 equalizer's length 128 FFT and its frequency domain output is then appropriately modified to compensate for channel 15 induced distortions. This modified output is then placed into a length 128 IFFT whose output will be the equalized half-symbol in the time domain.

Another approach to compensate for the phase and amplitude channel distortions would be to instead perform time domain equalization in receiver 16 at processor 48 (or alternatively special processor 40). Processor 48 (or alternatively special processor 40) can include a filter which has an impulse response designed to compensate for the received half-symbol's channel induced phase and amplitude distortions.

In all multicarrier systems the issue of how to reduce the PAR (Peak-to-Average-power Ratio) must be addressed. One way of reducing PAR for the present invention would be to have short FIR filters with a non-linear phase response located in element 20 (after the IFFT) and in element 40, or alternatively in element 20 (after the IFFT) and before the FFT in processor 48. The receiver filter would be the inverse of the transmitter filter. The filter implemented at transmitter 14 would have the effect of scrambling the phases and thus reducing the PAR. The transmitter filter could also be implemented rather as a set of 1-tap filters on the IFFT inputs at element 20.

It should be apparent that the invention not only accomplishes the major functions required from such apparatus, but does so in a particularly advantageous manner. It should be equally apparent, however, that various minor and equivalent modifications from the embodiments disclosed herein for illustrative purposes could be employed without departing from the shown at FIG. 5. The synthetic full symbol is an entity not to be found in the prior art. The synthetic full symbol is subsequently demodulated in conventional fashion at element 52 to yield as closely as possible the original transmitted data.

Note that although FIG. 5 depicts adding a modified copy at the end of the processed half-symbol to achieve synthetic full symbol 78, the technique would work just as well if the reverse were to be done. In other words, the original half-symbol could be the second half of the original full symbol and then the modified copy would be added at the front of the processed half-symbol to form the synthetic full symbol.

Any symbol transmitted over any channel from any multicarrier system will be subject to amplitude and phase distortions. One approach to compensate for these channel distortions is to perform frequency domain equalization at element 20. In preferred embodiments, pre-equalization is performed at element 20 by appropriately compensating for the amplitude and phase distortions before executing the IFFT.

Another approach would be to instead, perform frequency domain equalization in receiver 16 at element 48. This could be done by processing the inputted (into element 48) half-symbol samples directly with a frequency domain equalizer of length 128 FFT/IFFT. This frequency domain equalizer is designed to compensate the received half-symbol's 64 basis functions for the phase and amplitude distortions introduced to those 64 basis functions by channel 15. The inputted half-symbol samples are first placed in the essence of the invention. It is to be understood, therefore, that the invention should be regarded as encompassing not only the subject matter literally defined by the claims which follow, but also technical equivalents thereof.

What is claimed is:

1. A method of transmitting information, the method comprising:
(a) obtaining a waveform containing the information, the waveform presenting a first sequential portion and a second sequential portion, the first and second portions having substantial symmetry and substantial equality in length;
(b) transmitting one, but not both, of the two portions to a receiver;
(c) duplicating the transmitted portion;
(d) processing the duplicated portion by reversing it; and
(e) sequentially combining the transmitted half with the processed, duplicated half to reform substantially the original waveform.

2. The method of claim 1 wherein the waveform is suitable for presentation as a set of summed subcarrier waveforms, each subcarrier having an associated phase, wherein each subcarrier phase is restricted to the values of 0 and π.

3. The method of claim 1 wherein the waveform is suitable for presentation as a set of summed subcarrier waveforms, each subcarrier having an associated phase, wherein each subcarrier phase is restricted to the values of π/2 and 3π/2.

4. The method of claim 1 wherein transmitting one portion of the waveform occurs on an xDSL platform.

5. The method of claim 1 wherein transmitting one portion of the waveform occurs on a wireless platform.

6. The method of claim 1 wherein transmitting one portion of the waveform occurs on a copper wire platform.

7. The method of claim 1 wherein transmitting one portion of the waveform occurs on an OFDMA platform.

8. The method of claim 1 wherein transmitting one portion of the waveform occurs on an OFDM-CDMA platform.

9. The method of claim 1 wherein transmitting one portion of the waveform occurs on a fiber optic platform.

10. The method of claim 1 wherein transmitting one portion of the waveform occurs on a Filtered Multitone Modulation platform.

11. The method of claim 2 wherein at step (d) the duplicated portion is further processed by inverting it.

12. A method of transmitting information, utilizing an OFDM multicarrier waveform, the method comprising:
(a) obtaining the multicarrier waveform containing the information, the waveform presenting a first sequential portion and a second sequential portion, the first and second portions having substantial symmetry and substantial equality in length, the multicarrier waveform being suitable for presentation as a set of summed subcarrier waveforms, each subcarrier having a phase restricted to 0 and it, the amplitude of each subcarrier being freely variable;
(b) transmitting one, but not both, of the two portions to a receiver;
(c) duplicating the transmitted portion;
(d) processing the duplicated portion by reversing and inverting it; and
(e) sequentially combining the transmitted half with the processed, duplicated half to reform substantially the original waveform.

13. The method of claim 12 wherein transmitting one portion of the waveform occurs on a cable TV platform.

14. The method of claim 12 wherein equalization occurs after transmission of one portion.

15. The method of claim 12 wherein transmitting one portion of the waveform occurs on a fiber optic platform.

16. The method of claim 12 wherein transmitting one portion of the waveform occurs on powerline platform.

17. The method of claim 12 wherein prior to transmitting one portion of the waveform, the portion of the waveform is pre-equalized to mitigate distortion effects during transmission.

18. The method of claim 12 wherein prior to transmitting one portion of the waveform, the portion of the waveform is PAR reduced.

19. A method of transmitting information, utilizing an OFDM multicarrier waveform, the method comprising:
(a) obtaining the multicarrier waveform containing the information, the waveform presenting a first sequential portion and a second sequential portion, the first and second portions having substantial symmetry and substantial equality in length, the multicarrier waveform presenting a set of subcarrier waveforms, each subcarrier having a phase value restricted to π/2 and 3π/2, the amplitude of each subcarrier being freely variable;
(b) transmitting one, but not both, of the two portions to a receiver;
(c) duplicating the transmitted portion;
(d) processing the duplicated portion by reversing it; and
(e) sequentially combining the transmitted half with the processed, duplicated half to reform substantially the original waveform.

20. The method of claim 19 wherein the transmitted portion of the waveform is equalized at the receiver.
